(19) United States
(12) Patent Application Publication
(10) Pub. No.: US 2026/0189864 A1
(43) Pub. Date: Jul. 2, 2026

(54) NETWORK-BASED PUBLIC ADDRESS RECEIVER

(71) Applicant: INTER-M CORPORATION, Yangju-si (KR)

(72) Inventors: Woo Geun LEE, Uijeongbu-si (KR); Jin Wook KIM, Gunpo-si (KR); Sang Min WOO, Seoul (KR); Kun Hee KIM, Uijeongbu-si (KR)

(73) Assignee: INTER-M CORPORATION, Yangju-si (KR)

(21) Appl. No.: 19/549,002

(22) Filed: Feb. 25, 2026

Related U.S. Application Data
(63) Continuation of application No. PCT/KR2024/012472, filed on Aug. 21, 2024.

(30) Foreign Application Priority Data
Aug. 25, 2023 (KR) 10-2023-0112140

(51) Int. Cl. H04R 27/00; H04H 20/61

(52) U.S. Cl. CPC H04R 27/00; H04H 20/61; H04R 2227/003

(57) ABSTRACT

There is disclosed a network-based public address (PA) receiver. The disclosed network-based PA receiver includes: a system-on-chip (SoC) including a processing system (PS) and programmable logic (PL); wherein the PS includes a processor that executes a software program that outputs audio data encoded in a particular audio data representation format based on first PA audio data received via a network; wherein the PL is programmed to provide first audio interface logic and second audio interface logic; wherein the first audio interface logic organizes the encoded audio data into first formatted audio data according to a first audio interface format; and wherein the second audio interface logic organizes an audio data payload of a particular transport protocol, extracted from second PA audio data received via the network, into second formatted audio data according to a second audio interface format.

### TECHNICAL FIELD

The present disclosure relates to a network-based public address (PA) receiver, and more particularly, to a network-based PA receiver with a system-on-chip (SoC) having integrated therein configurations for normal-latency reception and low-latency reception of audio data for network-based PA.

### BACKGROUND ART

A public address (PA) system is installed in an environment such as a building or a complex—for example, an apartment complex, a school, a government office, a large building, an airport, a shopping mall, or the like—and is configured to output audio, such as announcement messages or background music, over a wide area. The PA system may also have a function of providing emergency broadcasting to notify of emergency situations, for example, a fire, an explosion, flooding, a power outage, an earthquake, or the like, occurring in or around the environment in which the PA system is installed.

Recently, there have been numerous large-scale implementations of PA systems. In such an implementation, multiple regional facilities are connected via a network. In this regard, examples of conveying audio data via a network include: (i) a normal-latency audio reception apparatus (which may also be referred to as a general-purpose audio playback apparatus) that receives and plays audio data, such as an audio file, with latency up to a generally tolerable level over an Internet Protocol (IP) network such as a Transmission Control Protocol (TCP)/IP network; and (ii) a low-latency audio reception apparatus that receives and processes audio data, such as an uncompressed audio stream, with low latency over an IP network according to a Layer-3-based audio data delivery solution, such as Layer-3 networking (e.g., DANTE, Ravenna, Q-LAN, or the like), and possibly also according to Layer-2 networking, such as Audio Video Bridging (AVB) networking or another type of Audio over Ethernet (AoE) networking. The general-purpose audio playback apparatus may include a general-purpose central processing unit (CPU), a memory, a networking device such as a network interface card (NIC), and an audio device such as an audio codec chip having a digital-to-analog converter (DAC) function, which are coupled to one another via a bus (including, e.g., a 32-bit bus). Audio data received via the networking device may be sufficiently buffered in the memory for playback via the bus, shared with the general-purpose CPU via the bus (e.g., for subsequent processing), and provided to the audio device via the bus in a format compliant with an audio interface such as Inter-IC Sound (I²S). The low-latency audio reception apparatus may provide received audio data for playback through a predetermined audio interface (e.g., a time-division multiplexing (TDM) audio interface that allows audio data having two or more channels to be transferred via a single data line) in accordance with a synchronized clock or a variable clock. Such a clock signal may be generated based on precision time protocol (PTP) information (e.g., clock synchronization information signaled according to PTP version 2 as used in AES67), or based on an occupancy level of an audio buffer (e.g., as disclosed in Korean Patent No. 10-2400936).

Many conventional network-based PA systems use general-purpose audio playback apparatuses (whose general-purpose CPUs are operable as, e.g., I²S masters) on the receiving side to implement basic PA functions, for example, scheduled broadcasting using an audio file or text-to-speech (TTS) broadcasting, as well as emergency broadcasting such as fire guidance broadcasting. However, these systems do not provide a function for receiving audio data with low latency over a network and thus have difficulty achieving high quality when providing, for example, background music through a local area network (LAN) in a building under normal conditions, due to the occurrence of transmission latency, echo, or the like.

Implementing a network-based PA system by additionally including, in such a general-purpose audio playback apparatus, a separate hardware module/chip for low-latency audio reception would involve another processor (e.g., a digital signal processor) that is responsible for switching between outputting audio data from the general-purpose CPU (e.g., according to an I²S protocol) and outputting audio data from the additional hardware module/chip (e.g., according to a non-I²S protocol such as a TDM protocol for transmission of audio data with more than two channels). Such an implementation is not cost-effective. Moreover, when the basic PA functions encompass performing PA at a remote location over a network that includes a wide area network (WAN) as well as a local area network (LAN) (e.g., centralized control broadcasting such as civil defense broadcasting), additional equipment may be required, such as a network bridge or a network switch for WAN communication, a device that converts an analog audio signal into audio data to be conveyed through the network, or the like. Accordingly, a network-based PA system implemented in this manner may be hard-pressed to be price-competitive in practice.

### DISCLOSURE OF THE INVENTION

### Technical Problem

A network-based public address receiver is disclosed herein.

### Solution to Problem

In an example, a network-based public address (PA) receiver includes: a system-on-chip (SoC) including a processing system (PS) and programmable logic (PL); wherein the PS includes a processor that executes a software program that outputs audio data encoded in a particular audio data representation format based on first PA audio data received via a network; wherein the PL is programmed to provide first audio interface logic and second audio interface logic; wherein the first audio interface logic organizes the encoded audio data into first formatted audio data according to a first audio interface format; and wherein the second audio interface logic organizes an audio data payload of a particular transport protocol, extracted from second PA audio data received via the network, into second formatted audio data according to a second audio interface format.

The foregoing summary is provided to introduce, in a simplified form, a few aspects that are further described below in the Detailed Description. This summary is not intended to identify key or essential features of the claimed subject matter, nor is it intended to be used to delimit the scope of the claimed subject matter. Furthermore, the claimed subject matter is not limited to implementations that provide any or all advantages discussed herein.

### Advantageous Effect of the Invention

According to the present disclosure, normal-latency and low-latency reception architectures for network-based PA audio data can be integrated on a single processing platform, thereby enabling efficient reception and processing of such PA audio data.

According to the present disclosure, various approaches for implementing a network-based PA receiver are provided, which approaches may be considered in conjunction with design factors of the network-based PA receiver, such as an acceptable level of data reception latency, the number of supported audio streams, manufacturing cost, and/or operational stability.

### BRIEF DESCRIPTION OF THE DRAWINGS

FIG. 1 illustrates an example network-based PA system in which audio data for public address (PA) is conveyed in a networked environment.

FIG. 2 illustrates an example of a system-on-chip (SoC) usable for implementing the network-based PA receiver of FIG. 1.

FIG. 3 illustrates an example implementation of the network-based PA receiver of FIG. 1.

FIG. 4 illustrates another example implementation of the network-based PA receiver of FIG. 1.

FIG. 5 illustrates yet another example implementation of the network-based PA receiver of FIG. 1.

### DETAILED DESCRIPTION OF THE EMBODIMENTS

Various terms used in the present disclosure are chosen from terminology for commonly used terms in view of their usage herein, which may be perceived differently depending on the perspective of a person skilled in the art, prior practice, or the emergence of new technology. In specific instances, some terms are ascribed their meanings as set forth in the detailed description. Accordingly, the terms used herein are to be defined consistently with their meanings in the context of the present disclosure, rather than simply by their names.

The terms “comprising,” “including,” “having,” etc. are used herein when specifying the presence of the elements listed thereafter, for example, certain features, numbers, steps, operations, constituent elements, information, or a combination thereof. Unless otherwise indicated, these terms and variations thereof are not meant to exclude the presence or addition of other elements.

As used herein, the terms “first,” “second,” and so forth are meant to identify several similar elements. Unless otherwise specified, such terms are not intended to impose limitations, for example, a particular order of these elements or of their use, but rather are used merely for referring to multiple elements separately. For instance, an element may be referred to in an example with the term “first” while the same element may be referred to in another example with a different ordinal number such as “second” or “third.” In such examples, these terms are not to limit the scope of the present disclosure. Also, the use of the term “and/or” in a list of multiple elements is inclusive of all possible combinations of the listed items, including any one or plurality of the items. Further, singular expressions include plural expressions unless expressly stated otherwise.

Certain examples of the present disclosure will now be described in detail with reference to the accompanying drawings. The present disclosure may, however, be embodied in many different forms and should not be construed as limited to the examples set forth herein; rather, these examples are given in order to provide a better understanding of the scope of the present disclosure.

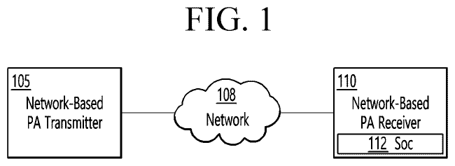

FIG. 1 illustrates an example network-based PA system 100 in which audio data for PA is conveyed in a networked environment. The example network-based PA system 100 may provide PA throughout a target environment, for example, an indoor and/or outdoor environment of the following: a complex including multiple buildings; a collection of local offices distributed across multiple remote locations; at least a portion of a building; an architectural structure; or the like. For example, the target environment may be divided into a plurality of zones, and performing PA through the PA system 100 may include broadcasting the same or different notifications, such as a voice alarm, across some zones.

In the example of FIG. 1, the network-based PA system 100 includes a network-based PA transmitter 105, a network-based PA receiver 110, and a network 108.

The network-based PA transmitter 105 may transmit, over the network 108 to the network-based PA receiver 110, audio data in a certain format that is based on source audio data from, for example, a compact disc player (CDP), a text-to-speech (TTS) synthesizer, a remote microphone (RM), or the like.

The network 108 may include a wired and/or wireless network, for example, a local area network (LAN), a metropolitan area network (MAN), a wide area network (WAN), the Internet, a virtual private network (VPN), or a combination thereof, and may be, in particular, an IP-based network.

The network-based PA receiver 110 may be deployed in any type of device that receives PA audio data from the network-based PA transmitter 105 via the network 108 on a receiving side of the network-based PA system 100. Such a device may have any suitable type of additional functionality. For example, the device may be capable of: generating and outputting an amplified audio signal from the received PA audio data; routing, to one or more audio output channels, one or more audio signals generated from the received PA audio data; assigning each audio output channel to an audio processing device such as an audio amplifier, a speaker, an audio mixer, and/or an audio matrix, or allocating each audio output channel to a certain zone of the target environment of the network-based PA system 100, for example, enabling or disabling relaying each audio output channel to at least one speaker installed in that zone; and/or driving a speaker transducer while serving as a power over Ethernet (PoE) switch. The network-based PA receiver may be implemented to include a system-on-chip (SoC) 112, wherein the SoC 112 includes a processing system (PS) that includes a processor that executes a software program that outputs audio data encoded in a particular audio data representation format based on first PA audio data received via a network, and wherein the SoC 112 further includes programmable logic (PL) that is programmed to provide: audio interface logic that organizes the encoded audio data into formatted audio data according to an audio interface format; and different audio interface logic that organizes an audio data payload of a particular transport protocol, extracted from different PA audio data received via the network, into different formatted audio data according to a different audio interface format.

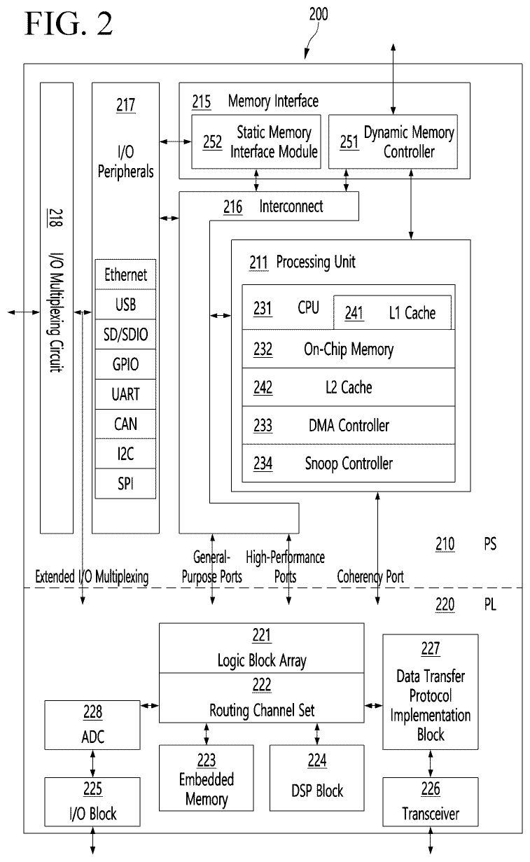

FIG. 2 illustrates an example of a system-on-chip (SoC) usable for implementation of the network-based PA receiver 110.

In the example of FIG. 2, the example SoC 200 includes a processing system (PS) 210 and programmable logic (PL) 220 integrated on a single chip and interconnected with each other. In some example implementations, power management for the PS 210 and power management for the PL 220 may be performed separately. For example, power may be supplied to the PS 210, whereas power to the PL 220 may be cut off.

In the example of FIG. 2, the PS 210 includes a processing unit 211, which includes a CPU 231 (e.g., a multi-core processor), an on-chip memory 232, and a direct memory access (DMA) controller 233.

As illustrated in FIG. 2, the PS 210 may further include a memory interface 215, an interconnect 216, input/output (I/O) peripherals 217, and an I/O multiplexing circuit 218. The processing unit 211 may be interconnected with other components of the PS 210, such as the memory interface 215 and the I/O peripherals 217, through the interconnect 216. The PS 210 may further be interconnected with the PL 220 through the interconnect 216.

The PS 210 may provide software programmability using a well-defined instruction set of the CPU 231, such as an ARM architecture instruction set. In this regard, an operating system (OS) (e.g., a Linux-based OS) may be executed on the CPU 231, for example, independently of the PL 220.

In some example implementations, the CPU 231 may have an L1 cache 241 per processing core. The processing unit 211 may further include an L2 cache 242 shareable among processing cores of the CPU 231. Further, the processing unit 211 may further include a snoop controller 234 that maintains L1 and L2 coherency.

In some example implementations, the on-chip memory 232 may include a random access memory (RAM), such as a static RAM (SRAM). The on-chip memory 232 may be accessed by the CPU 231 and also by the interconnect 216. Further, the on-chip memory 232 may be directly accessed by the PL 220, for example, through a coherency port that accelerates communication between the processing unit 211 and the PL 220 while enabling cache coherent access.

In some example implementations, the DMA controller 233 may enable a plurality of DMA channel threads to be executed in parallel. The DMA controller 233 may provide channels for memory-to-memory transfers within the SoC 200, and may also support connections with DMA-capable peripherals residing in the PL 220.

In some example implementations, the memory interface 215 may include: a dynamic memory controller 251 that allows the PS 210 and the PL 220 to share and access a synchronous dynamic RAM (SDRAM) that is based on a predetermined memory interface standard (e.g., double data rate (DDR)), such as DDR2, LPDDR2, DDR3, or DDR3L SDRAM; and a static memory interface module 252 that supports an external static memory. The dynamic memory controller 251 may have, for example, a port dedicated to the CPU 231, a port dedicated to the PL 220, and a port shared through the interconnect 216. The static memory interface module 252 may operate, for example, in a NAND flash interface mode or in an asynchronous SRAM/NOR flash parallel interface mode.

In some example implementations, the interconnect 216 may be configured as a multi-channel bus architecture, for example, may include an AMBA AXI interconnect. For example, the PS 210 and the PL 220 may communicate with each other through at least one of a general-purpose port (e.g., an M_AXI_GP port and an S_AXI_GP port) and a high-performance port (e.g., an S_AXI_HP port), which are provided on the interconnect 216 according to the architecture. Further, a quality of service (QoS) block for controlling data traffic through the interconnect 216 may be included in the interconnect 216.

In some example implementations, the I/O peripherals 217 may include various data communication peripherals, such as an Ethernet controller, a USB controller, an SD/SDIO controller, a GPIO module, a UART controller, a CAN bus interface controller, an I2C controller, and an SPI bus controller.

In some example implementations, the I/O multiplexing circuit 218 may multiplex accesses by the I/O peripherals 217 and the static memory interface module 252 for communication with external devices.

In the example of FIG. 2, the PL 220 includes a logic block array 221 and a routing channel set 222. Each logic block in the array 221 includes logic circuitry that is reconfigurable to implement logic functions, such as reconfigurable combinational logic circuitry and/or reconfigurable sequential logic circuitry. The routing channel set 222 is configured with interconnect elements such as wiring for interconnection among logic blocks in the array 221. In particular, each logic block in the array 221 may include one or more logic elements, wherein each logic element may include: a look-up table (LUT) having a plurality of inputs; a flip-flop (FF) to which an output of the LUT and a clock signal are input; and an additional FF that operates as a latch. Accordingly, using programmable interconnectivity of routing channels in the set 222 and reconfigurable logic features provided by logic blocks in the array 221, for example, through a field programmable gate array (FPGA) architecture logic design, the PL 220 may provide hardware programmability. For example, a boot process of the SoC 200 may involve booting the processing unit 211 of the PS 210 first, and thus the PL 220 may be configured, in whole or in part, in a software-friendly manner during or after the boot process of the SoC 200.

The PL 220 may also include various support circuits, as illustrated in FIG. 2, such as an embedded memory 223 (e.g., a block RAM), a digital signal processing (DSP) block 224, an I/O block 225, a transceiver 226, a data transfer protocol implementation block 227, and an analog-to-digital converter (ADC) 228. The support circuits of the PL 220 may be connected to logic blocks in the array 221 through programmable interconnect elements, for example, in the routing channel set 222. Introducing these support circuits into the PL 220 allows more logic blocks in the array 221 to be programmed and used to provide application-specific logic. Some support circuits of the PL 220 may be programmable blocks or may include programmable modules. Some support circuits of the PL 220 may be dedicated blocks, for example, fixed-function circuitry built with transistors and having higher performance and lower power consumption.

In some example implementations, the embedded memory 223 may include a plurality of block RAMs. Each block RAM may have multiple independent ports that share stored data (e.g., the block RAM may be a dual-port 36 KB block RAM), and each port may have a programmable data width, such as up to a 72-bit width.

In some example implementations, the DSP block 224 may include a plurality of DSP elements, wherein each DSP element is configured to perform multiplier and accumulator (MAC) operations. The DSP block 224 may further include additional elements such as a pre-adder or a pattern detector.

In some example implementations, the I/O block 225 may support a plurality of I/O standards to provide communication between the PL 220, such as logic blocks in the array 221, and an external device. The I/O block 225 may support relatively high-performance operations with support for a relatively low maximum voltage, or may have a relatively wider range of supported voltages. Further, the I/O block 225 may be accessed, instead of the I/O multiplexing circuit 218, for communication between the I/O peripherals 217 of the PS 210 and an external device, for example, through interface circuitry for extended I/O multiplexing between the PS 210 and the PL 220.

In some example implementations, the transceiver 226 may include serial transceiver circuitry. The serial transceiver circuitry may serve as a serial transceiver module, for example, a low-power module having a line data rate of several Gbps to about 10 Gbps, that is configured as a combination of a transmitter and a receiver. The serial transceiver circuitry may also have a number of features and parameters that may be defined by a user during configuration of the PL 220, and some of these features and parameters may be modified, in particular, during operation of the PL 220.

In some example implementations, the data transfer protocol implementation block 227 may be interfaced with the transceiver 226. By way of example, the data transfer protocol implementation block 227 may operate one or more PCI Express lanes for the serial transceiver circuitry of the transceiver 226, for example, at a data rate of several Gbps. The data transfer protocol implementation block 227 may also be interfaced with the embedded memory 223 for data buffering.

In some example implementations, the ADC 228 may be configured as an analog multiplexer that multiplexes a number of configurable analog inputs, and as a track-and-hold amplifier that supports various types of analog input signals, such as unipolar, bipolar, and differential analog input signals. Software operating on the PS 210 may communicate with the ADC 228 through the interconnect 216 and control the ADC 228.

As discussed in detail below, the network-based PA receiver 110 may be implemented in various manners. Selection of an approach for implementing the network-based PA receiver 110 may depend, for example, on one or more of the following: an acceptable level of data reception latency, the number of supported audio streams, manufacturing cost, and/or operational stability of the network-based PA receiver 110.

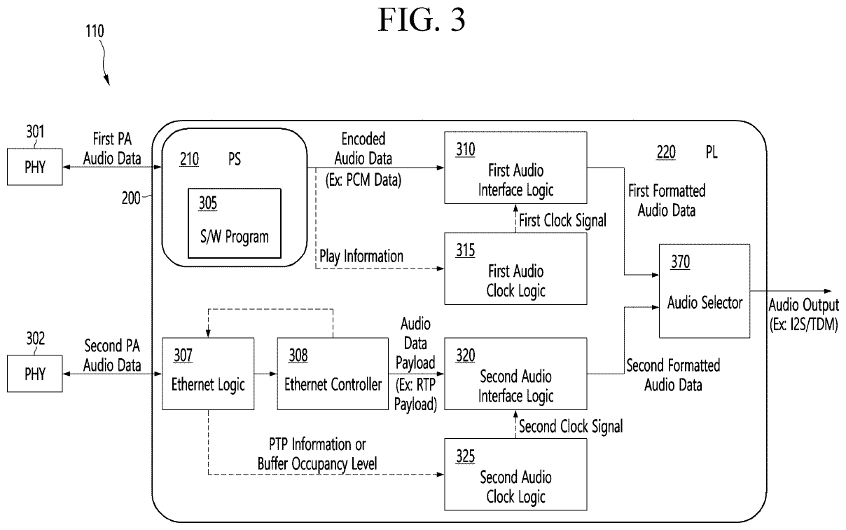

FIG. 3 illustrates an example implementation of the network-based PA receiver 110. In the illustrated example, the network-based PA receiver 110 includes the SoC 200, a first physical layer (PHY) device 301, and a second PHY device 302. By way of example, the first PHY device 301 may implement a physical transmission medium that provides Ethernet connectivity between the network 108 and the PS 210 of the SoC 200 and on which, for example, a physical link for communication of a data bitstream may be established. The first PHY device 301 may be interfaced with a medium access control (MAC) layer of the PS 210 (e.g., included in an Ethernet controller of the I/O peripherals 217). Similarly, the second PHY device 302 may implement a physical transmission medium that provides Ethernet connectivity between the network 108 and the PL 220 of the SoC 200 and on which, for example, a physical link for communication of a data bitstream may be established. The second PHY device 302 may be interfaced with a MAC layer of the PL 220 (e.g., included in Ethernet processing logic implemented with a functional logic module such as an intellectual property (IP) core). Each of the PHY devices 301 and 302 may be a chip external to the SoC 200.

In the example of FIG. 3, the I/O peripherals 217 of the PS 210, which include, for example, an Ethernet controller, may control Ethernet communication and may receive first PA audio data (e.g., a streamed MP3 or WAV file) via the network 108 in the Ethernet communication and through a physical link established between the network 108 and the PS 210 by the first PHY device 301.

In some example implementations, the first PA audio data may be susceptible to reception latency up to a usual level, and the network-based PA receiver 110 may tolerate such normal-latency reception as well. In other words, the first PA audio data may be used for output of PA sound of usual quality. For example, the first PA audio data may be received over the network 108 (e.g., a LAN and/or a WAN in the network 108) in Transmission Control Protocol (TCP) packets or in User Datagram Protocol (UDP) packets.

In the example of FIG. 3, the processing unit 211 of the PS 210 may execute a software program 305 on the CPU 231, wherein the software program 305 may be configured to generate and output audio data encoded in a particular audio data representation format based on the received first PA audio data. For example, such encoded audio data may be audio data having an uncompressed digital audio representation format (e.g., pulse-code modulation (PCM)-encoded audio data), and may be provided to the PL 220 through the interconnect 216 of the PS 210 (e.g., an AXI interconnect).

As illustrated in FIG. 3, the software program 305 may also be configured to construct and output play information regarding the encoded audio data. For example, the play information may include the number of channels in the encoded audio data, a sample rate of the encoded audio data, and/or a bit depth of the encoded audio data.

In the example of FIG. 3, the PL 220 may be programmed (e.g., by configuring at least some of the components 221-228 of the PL 220) to provide first audio interface logic 310, first audio clock logic 315, Ethernet logic 307, an Ethernet controller 308, second audio interface logic 320, second audio clock logic 325, and an audio selector 370.

The first audio interface logic 310 may be configured to organize the encoded audio data provided from the PS 210 into first formatted audio data according to a first audio interface format (e.g., an I²S interface format). In particular, as illustrated in FIG. 3, the first audio clock logic 315 may generate, based on the play information provided from the PS 210, a first clock signal (e.g., as a clock signal having a selected clock frequency from among a number of candidate clock frequencies), and may output the first clock signal to the first audio interface logic 310. Then, while organizing the encoded audio data into the first formatted audio data, the first audio interface logic 310 may provide the first formatted audio data in accordance with the first clock signal.

The Ethernet logic 307 may be configured to receive second PA audio data (e.g., audio data packets delivered according to an audio networking technology which is based on protocols, standards, and/or solutions such as DANTE, AES67, and AVB) via the network 108 in Ethernet communication controlled by the Ethernet controller 308, and through a physical link established between the network 108 and the PL 220 by the second PHY device 302, separately from the first PA audio data, and to provide the received second PA audio data to the Ethernet controller 308. For example, the second PA audio data may be received over the network 108 (e.g., a LAN in network 108) in UDP packets, and may be subject to low-latency reception. Thus, the second PA audio data may be used for output of high-quality PA sound.

The Ethernet controller 308 may be configured to control the Ethernet communication (e.g., by negotiating a data link for the Ethernet communication to manage traffic in the Ethernet communication), and also to extract, from the second PA audio data, an audio data payload of a particular transport protocol and to output the extracted audio data payload to the second audio interface logic 320. For example, the particular transport protocol may be a stateless protocol in the Real-time Transport Protocol (RTP) family.

The second audio interface logic 320 may be configured to organize the extracted audio data payload into second formatted audio data according to a second audio interface format (e.g., a time-division multiplexing (TDM) interface format that is other than an I²S interface format). In particular, as illustrated in FIG. 3, the Ethernet logic 307 may derive, using the second PA audio data, precision time protocol (PTP) information (e.g., including timestamp values extracted from PTP messages carried in the second PA audio data and/or other types of synchronized clock information obtained based on such values), or may identify, by buffering the second PA audio data in an audio buffer (e.g., a buffer such as a first-in-first-out (FIFO) buffer included in the embedded memory 223), a buffer occupancy level indicating an amount of the second PA audio data currently remaining in the audio buffer. The second audio clock logic 325 may generate, based on the derived PTP information or the identified buffer occupancy level, a second clock signal (e.g., a clock signal synchronized according to the PTP information, or a clock signal adjusted such that a clock frequency is variably set based on the buffer occupancy level), and may output the second clock signal to the second audio interface logic 320. Then, while organizing the audio data payload into the second formatted audio data, the second audio interface logic 320 may provide the second formatted audio data in accordance with the second clock signal.

The audio selector 370 may be configured to provide, based on at least one of the first formatted audio data and the second formatted audio data, an audio output (e.g., output audio data in an I²S format or a TDM format, as illustrated in FIG. 3). For example, the audio selector 370 may include a switch (e.g., a multiplexer switch) for switching between providing the first formatted audio data as the audio output and providing the second formatted audio data as the audio output. As another example, the audio selector 370 may include an audio matrix that provides the audio output by routing, to one or more output channels in the audio output, at least one channel in the first formatted audio data, at least one channel in the second formatted audio data, or both. Such routing may include: delivering one channel in the first formatted audio data or the second formatted audio data to one output channel in the audio output; and/or combining, into one output channel in the audio output, multiple channels in the first formatted audio data, multiple channels in the second formatted audio data, or at least one channel in the first formatted audio data and at least one channel in the second formatted audio data. In this regard, it would be appreciated that one channel in the first formatted audio data or the second formatted audio data may be allocated to multiple output channels. By way of example, at least one channel in the first formatted audio data may be routed to a first output channel in the audio output and sent from the audio matrix to at least one audio processing apparatus (e.g., a speaker), at least one channel in the second formatted audio data may be routed to a second output channel in the audio output and sent from the audio matrix to at least one further audio processing apparatus (e.g., an amplifier), and a combination of at least one channel in the first formatted audio data and at least one channel in the second formatted audio data may be routed to a third output channel in the audio output and sent from the audio matrix to at least one additional audio processing apparatus (e.g., another speaker).

In some example implementations, the audio selector 370 may further include an asynchronous sample rate converter (ASRC) that resamples, in accordance with an output clock signal, the first formatted audio data (e.g., synchronized with the first clock signal) and/or the second formatted audio data (e.g., synchronized with the second clock signal). The audio selector 370 may provide such resampled audio data as the audio output.

When implemented as illustrated in FIG. 3, the network-based PA receiver 110 may provide stable operation with respect to link redundancy, while requiring relatively more external devices (e.g., the PHY devices) and relatively more logic resources (e.g., logic blocks in the PL 220), since the PS 210 and the PL 220 manage their respective Ethernet communications. By way of example, such an implementation may be considered in combination with an audio matrix apparatus.

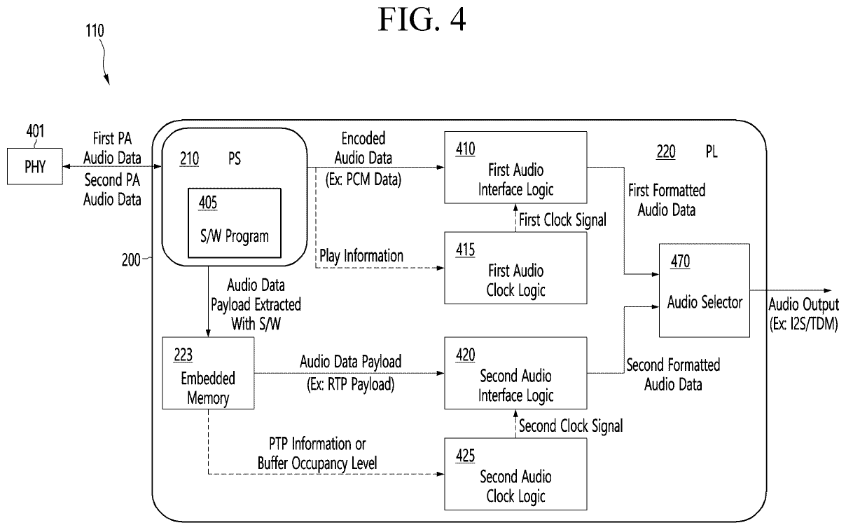

FIG. 4 illustrates another example implementation of the network-based PA receiver 110. In the illustrated example, the network-based PA receiver 110 includes the SoC 200 and a physical layer (PHY) device 401. For example, the PHY device 401 may implement a physical transmission medium that provides Ethernet connectivity between the network 108 and the PS 210 of the SoC 200 and on which, for example, a physical link for communication of a data bitstream may be established. The PHY device 401 may be interfaced with a medium access control (MAC) layer of the PS 210 (e.g., included in an Ethernet controller of the I/O peripherals 217). The PHY device 401 may be a chip external to the SoC 200.

In the example of FIG. 4, the I/O peripherals 217 of the PS 210 (e.g., including an Ethernet controller) may control Ethernet communication and may be configured to receive first PA audio data and second PA audio data via the network 108 in the Ethernet communication and through a physical link established between the network 108 and the PS 210 by the PHY device 401. The first and second PA audio data referenced in this example may respectively have characteristics similar to those of the first and second PA audio data described above with reference to FIG. 3.

In the example of FIG. 4, the processing unit 211 of the PS 210 may execute a software program 405 on the CPU 231. The software program 405 may be configured to perform the above-described operations of the software program 305.

As illustrated in FIG. 4, the software program 405 may also be configured to extract, from the received second PA audio data, an audio data payload of a particular transport protocol (e.g., an RTP payload), and to store the extracted audio data payload in the embedded memory 223 of the PL 220 via the interconnect 216 of the PS 210 (e.g., an AXI interconnect).

Further, unlike the example of FIG. 3, the software program 405, rather than logic implemented in the PL 220, may derive, using the second PA audio data, precision time protocol (PTP) information (e.g., including the synchronized clock information described above), or may identify, by buffering the second PA audio data in an audio buffer (e.g., a buffer included in the on-chip memory 232 or another memory), a buffer occupancy level indicating an amount of the second PA audio data currently remaining in the audio buffer.

In the example of FIG. 4, the PL 220 may be programmed (e.g., by configuring at least some of the components 221-228 of the PL 220) to provide first audio interface logic 410, first audio clock logic 415, second audio interface logic 420, second audio clock logic 425, and an audio selector 470. These may operate in the same manner as the first audio interface logic 310, the first audio clock logic 315, the second audio interface logic 320, the second audio clock logic 325, and the audio selector 370 described above with reference to FIG. 3, except that: (i) in the example of FIG. 4, the second audio interface logic 420 reads out the audio data payload from the embedded memory 223, rather than receiving the audio data payload from logic implemented in the PL 220; and (ii) as illustrated in FIG. 4, the second audio clock logic 425 reads out the PTP information or the buffer occupancy level from the embedded memory 223, rather than receiving the PTP information or the buffer occupancy level from logic implemented in the PL 220.

When implemented as illustrated in FIG. 4, the network-based PA receiver 110 may manage Ethernet communication solely by the I/O peripherals 217 of the PS 210 and employ relatively fewer resources (e.g., logic blocks) in the PL 220, while processing, in software, even audio data that is subject to low-latency reception, thereby potentially posing a challenge of buffering latency. For example, such an implementation may be considered for pursuing downsizing of a device such as an IP speaker, which can typically process a single audio stream.

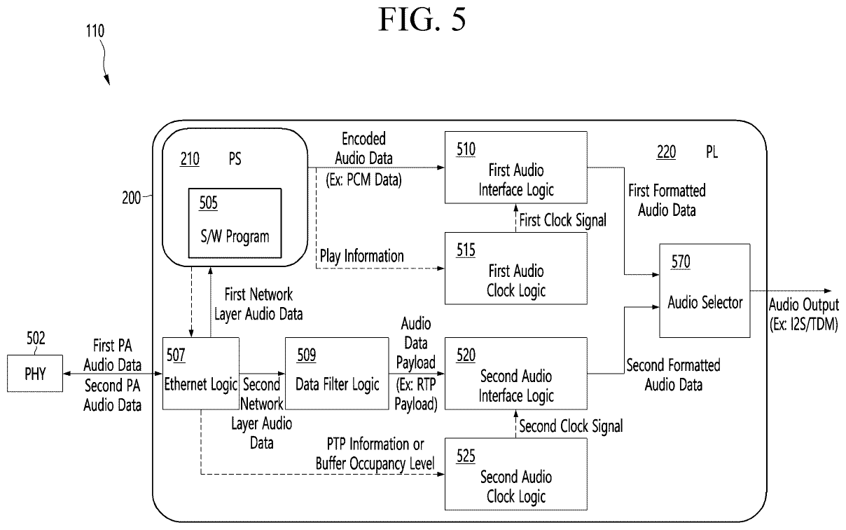

FIG. 5 illustrates yet another example implementation of the network-based PA receiver 110. In the illustrated example, the network-based PA receiver 110 includes the SoC 200 and a physical layer (PHY) device 502. For example, the PHY device 502 may implement a physical transmission medium that provides Ethernet connectivity between the network 108 and the PL 220 of the SoC 200 and on which, for example, a physical link for communication of a data bitstream may be established. The PHY device 502 may be interfaced with a medium access control (MAC) layer of the PL 220 (e.g., included in Ethernet processing logic implemented with a functional logic module such as an intellectual property (IP) core). The PHY device 502 may be a chip external to the SoC 200.

In the example of FIG. 5, the PL 220 may be programmed (e.g., by configuring at least some of the components 221-228 of the PL 220) to provide Ethernet logic 507, data filter logic 509, first audio interface logic 510, first audio clock logic 515, second audio interface logic 520, second audio clock logic 525, and an audio selector 570. In this example, the first audio interface logic 510, the first audio clock logic 515, the second audio interface logic 520, the second audio clock logic 525, and the audio selector 570 may operate in the same manner as the first audio interface logic 310, the first audio clock logic 315, the second audio interface logic 320, the second audio clock logic 325, and the audio selector 370 described above with reference to FIG. 3.

The Ethernet logic 507 may be configured to receive first PA audio data and second PA audio data via the network 108 in Ethernet communication (e.g., controlled by an Ethernet controller of the I/O peripherals 217 of the PS 210) and through a physical link established between the network 108 and the PL 220 by the PHY device 502. The first and second PA audio data referenced in this example may respectively have characteristics similar to those of the first and second PA audio data described above with reference to FIG. 3.

As illustrated in FIG. 5, the Ethernet logic 507 may also be configured to extract first network-layer audio data (e.g., IP packets) from the received first PA audio data and to provide the extracted first network-layer audio data to the PS 210. In this example, the processing unit 211 of the PS 210 may execute a software program 505 on the CPU 231, wherein the software program 505 may be configured to generate and output audio data encoded in a particular audio data representation format (e.g., pulse-code modulation (PCM)-encoded audio data) based on the first network-layer audio data provided from the Ethernet logic 507, and may also be configured to construct and output play information regarding the encoded audio data (e.g., the number of channels in the encoded audio data, a sample rate of the encoded audio data, and/or a bit depth of the encoded audio data).

In the illustrated example, the Ethernet logic 507 may also be configured to extract, from the received second PA audio data, second network-layer audio data that includes an audio data payload of a particular transport protocol (e.g., Real-time Transport Protocol (RTP)), and to provide the extracted second network-layer audio data to the data filter logic 509. For example, the second network-layer audio data may be an IP packet, and this packet may include encapsulated RTP data, that is, an RTP payload.

Further, in a manner similar to the Ethernet logic 307 described above with reference to FIG. 3, the Ethernet logic 507 may derive, using the second PA audio data, precision time protocol (PTP) information (e.g., including the synchronized clock information described above), or may identify, by buffering the second PA audio data in an audio buffer (e.g., a buffer included in the embedded memory 223), a buffer occupancy level indicating an amount of the second PA audio data currently remaining in the audio buffer. The derived PTP information or the identified buffer occupancy level may be provided from the Ethernet logic 507 to the second audio clock logic 525.

The data filter logic 509 may be configured to extract, from the second network-layer audio data provided from the Ethernet logic 507, the audio data payload of the particular transport protocol and to output the extracted audio data payload to the second audio interface logic 520.

When implemented as illustrated in FIG. 5, the network-based PA receiver 110 may manage Ethernet communication solely by logic implemented in the PL 220, and accordingly, assign relatively quickly acquired network-layer audio data for processing to the PS 210 or to the PL 220, depending on whether the audio data is subject to normal-latency reception or low-latency reception, while requiring relatively more resources to implement the data filter logic 509 in the PL 220. For example, such an implementation may be considered for inclusion in a device that processes multiple audio streams, such as a multi-channel amplifier.

In the implementations illustrated in FIG. 3, FIG. 4, or FIG. 5, the network-based PA receiver 110 may be further configured as discussed below.

In any of the examples of FIG. 3 to FIG. 5, the PL 220 may further include (2j+1)-th audio interface logic, where j is 1, 2, . . . , M (e.g., M=1). Such audio interface logic may format, according to a first audio interface format, audio data encoded in a particular audio data representation format, in the same manner as any of the first audio interface logic 310, 410, or 510. For convenience, audio data that is organized and output by the (2j+1)-th audio interface logic may be referred to as (2j+1)-th formatted audio data.

For example, the third audio interface logic, the fifth audio interface logic, . . . , and the (2M+1)-th audio interface logic may respectively provide the third formatted audio data, the fifth formatted audio data, . . . , and the (2M+1)-th formatted audio data in accordance with the first clock signal output from the first audio clock logic 315.

Alternatively, at least some of the first formatted audio data, the third formatted audio data, the fifth formatted audio data, . . . , and the (2M+1)-th formatted audio data may be provided in accordance with clock signals that are different from one another. For example, the PL 220 may further include third audio clock logic, fifth audio clock logic, . . . , and (2M+1)-th audio clock logic. The third audio clock logic may generate a third clock signal based on the play information provided from the PS 210 in the same manner as any of the first audio clock logic 315, 415, or 515, and may output the third clock signal to the third audio interface logic. The fifth audio clock logic may generate a fifth clock signal based on such play information and may output the fifth clock signal to the fifth audio interface logic, and . . . , the (2M+1)-th audio clock logic may generate a (2M+1)-th clock signal based on the same play information and may output the (2M+1)-th clock signal to the (2M+1)-th audio interface logic.

In any of the examples of FIG. 3 to FIG. 5, the PL 220 may further include (2k+2)-th audio interface logic, where k is 1, 2, . . . , N (e.g., N=1). Such audio interface logic may format, according to a second audio interface format, an extracted audio data payload of a particular transport protocol, in the same manner as any of the second audio interface logic 320, 420, or 520. For convenience, audio data that is organized and output by the (2k+2)-th audio interface logic may be referred to as (2k+2)-th formatted audio data.

For example, the fourth audio interface logic, the sixth audio interface logic, . . . , and the (2N+2)-th audio interface logic may respectively provide the fourth formatted audio data, the sixth formatted audio data, . . . , and the (2N+2)-th formatted audio data in accordance with the second clock signal output from the second audio clock logic 325.

Alternatively, at least some of the second formatted audio data, the fourth formatted audio data, the sixth formatted audio data, . . . , and the (2N+2)-th formatted audio data may be provided in accordance with clock signals that are different from one another. For example, the PL 220 may further include fourth audio clock logic, sixth audio clock logic, . . . , and (2N+2)-th audio clock logic. The fourth audio clock logic may generate a fourth clock signal based on the precision time protocol (PTP) information or buffer occupancy level that is provided in the same manner as any of the second audio clock logic 325, 425, or 525, and may output the fourth clock signal to the fourth audio interface logic. The sixth audio clock logic may generate a sixth clock signal based on such PTP information or buffer occupancy level and may output the sixth clock signal to the sixth audio interface logic, and . . . , the (2N+2)-th audio clock logic may generate a (2N+2)-th clock signal based on the same PTP information or buffer occupancy level and may output the (2N+2)-th clock signal to the (2N+2)-th audio interface logic.

In any of the examples of FIG. 3 to FIG. 5, the audio selector 370 may provide an audio output based on the first formatted audio data, the second formatted audio data, and/or the additional formatted audio data described above (that is, the third formatted audio data, the fifth formatted audio data, . . . , the (2M+1)-th formatted audio data, and/or the fourth formatted audio data, the sixth formatted audio data, . . . , the (2N+1)-th formatted audio data).

In some example implementations, the audio selector 370 may include a switch, for example, a multiplexer switch that when M=2 and N=1, provides, as an audio output, one of the first formatted audio data, the second formatted audio data, the third formatted audio data, the fourth formatted audio data, and the fifth formatted audio data.

In some example implementations, the audio selector 370 may include an audio matrix. For example, when M=2 and N=1, the audio matrix may provide an audio output by routing at least one channel in the first formatted audio data, at least one channel in the second formatted audio data, at least one channel in the third formatted audio data, at least one channel in the fourth formatted audio data, and/or at least one channel in the fifth formatted audio data to one or a plurality of output channels in the audio output. The one or each of the plurality of output channels may be sent from the audio matrix to at least one audio processing apparatus.

Additionally or alternatively, as described above, the audio selector 370 may include an ASRC. For example, when M=2 and N=1, the ASRC may resample at least one of the first formatted audio data, the second formatted audio data, the third formatted audio data, the fourth formatted audio data, and the fifth formatted audio data, and provide the resampled audio data as an audio output.

The following are various examples pertaining to a network-based PA receiver.

In Example 1, a network-based public address (PA) receiver includes: a system-on-chip (SoC) including a processing system (PS) and programmable logic (PL); wherein the PS includes a processor that executes a software program that outputs audio data encoded in a particular audio data representation format based on first PA audio data received via a network; wherein the PL is programmed to provide first audio interface logic and second audio interface logic; wherein the first audio interface logic organizes the encoded audio data into first formatted audio data according to a first audio interface format; and wherein the second audio interface logic organizes, into second formatted audio data according to a second audio interface format, an audio data payload of a particular transport protocol that is extracted from second PA audio data received via the network.

Example 2 includes the subject matter of Example 1, wherein the software program further outputs play information regarding the encoded audio data; wherein the PL is further programmed to provide first audio clock logic that provides, to the first audio interface logic, a first clock signal based on the play information; and wherein organizing the encoded audio data into the first formatted audio data includes providing the first formatted audio data in accordance with the first clock signal.

Example 3 includes the subject matter of Example 2, wherein the play information includes at least one of a number of channels in the encoded audio data, a sample rate of the encoded audio data, or a bit depth of the encoded audio data.

Example 4 includes the subject matter of any one of Examples 1 to 3, wherein the PL is further programmed to provide second audio clock logic that provides a second clock signal to the second audio interface logic based on precision time protocol (PTP) information derived using the second PA audio data or based on a buffer occupancy level indicating an amount of the second PA audio data currently remaining in an audio buffer, and wherein organizing the audio data payload into the second formatted audio data includes providing the second formatted audio data in accordance with the second clock signal.

Example 5 includes the subject matter of any one of Examples 1 to 3, wherein the PS further includes input/output (I/O) peripherals that control Ethernet communication and receive the first PA audio data via the network in the Ethernet communication; wherein the software program further generates the encoded audio data from the received first PA audio data; wherein the PL is further programmed to provide Ethernet logic and an Ethernet controller; wherein the Ethernet logic receives, via the network in separate Ethernet communication controlled by the Ethernet controller, the second PA audio data separately from the first PA audio data, and provides the received second PA audio data to the Ethernet controller; and wherein the Ethernet controller extracts the audio data payload from the second PA audio data and provides the extracted audio data payload to the second audio interface logic.

Examples 6 includes the subject matter of any one of Examples 1 to 3, wherein the PL is further programmed to provide second audio clock logic that provides a second clock signal to the second audio interface logic based on PTP information derived using the second PA audio data or based on a buffer occupancy level indicating an amount of the second PA audio data currently remaining in an audio buffer; wherein organizing the audio data payload into the second formatted audio data includes providing the second formatted audio data in accordance with the second clock signal; wherein the PS further includes input/output (I/O) peripherals that control Ethernet communication and receive the first PA audio data via the network in the Ethernet communication; wherein the software program further generates the encoded audio data from the received first PA audio data; wherein the PL is further programmed to provide Ethernet logic and an Ethernet controller; wherein the Ethernet logic receives via the network in separate Ethernet communication controlled by the Ethernet controller the second PA audio data separately from the first PA audio data, provides the received second PA audio data to the Ethernet controller, derives the PTP information using the received second PA audio data or identifies the buffer occupancy level by buffering the received second PA audio data in the audio buffer, and provides the derived PTP information or the identified buffer occupancy level to the second audio clock logic; and wherein the Ethernet controller extracts the audio data payload from the second PA audio data and provides the extracted audio data payload to the second audio interface logic.

Example 7 includes the subject matter of Example 5 or 6, wherein the network-based PA receiver further includes: a first physical layer (PHY) device that establishes a first physical link between the network and the PS; and a second PHY device that establishes a second physical link between the network and the PL; wherein the I/O peripherals receive the first PA audio data through the first physical link; and wherein the Ethernet logic receives the second PA audio data through the second physical link.

Example 8 includes the subject matter of any one of Examples 1 to 3, wherein the PS further includes I/O peripherals that control Ethernet communication and receive, via the network in the Ethernet communication, the first PA audio data and the second PA audio data; and wherein the software program further generates the encoded audio data from the received first PA audio data, extracts the audio data payload from the received second PA audio data, and stores the extracted audio data payload in an embedded memory of the PL.

Example 9 includes the subject matter of any one of Examples 1 to 3, wherein the PL is further programmed to provide second audio clock logic that provides a second clock signal to the second audio interface logic based on PTP information derived using the second PA audio data or based on a buffer occupancy level indicating an amount of the second PA audio data currently remaining in an audio buffer; wherein organizing the audio data payload into the second formatted audio data includes providing the second formatted audio data in accordance with the second clock signal; wherein the PS further includes I/O peripherals that control Ethernet communication and receive the first PA audio data and the second PA audio data via the network in the Ethernet communication; and wherein the software program further generates the encoded audio data from the received first PA audio data, derives the PTP information using the received second PA audio data or identifies the buffer occupancy level by buffering the received second PA audio data in the audio buffer, stores the derived PTP information or the identified buffer occupancy level in an embedded memory of the PL, extracts the audio data payload from the received second PA audio data, and stores the extracted audio data payload in the embedded memory.

Example 10 includes the subject matter of Example 8 or 9, wherein the network-based PA receiver further includes a PHY device that establishes a physical link between the network and the PS; and wherein the I/O peripherals receive, through the physical link, the first PA audio data and the second PA audio data.

Example 11 includes the subject matter of any one of Examples 1 to 3, wherein the PL is further programmed to provide Ethernet logic and data filter logic; wherein the Ethernet logic receives the first PA audio data and the second PA audio data via the network in Ethernet communication, extracts first network-layer audio data from the received first PA audio data, provides the extracted first network-layer audio data to the PS, extracts second network-layer audio data that includes the audio data payload from the received second PA audio data, and provides the extracted second network-layer audio data to the data filter logic; wherein the data filter logic extracts the audio data payload from the second network-layer audio data and provides the extracted audio data payload to the second audio interface logic; and wherein the software program further generates the encoded audio data from the extracted first network-layer audio data.

Example 12 includes the subject matter of any one of Examples 1 to 3, wherein the PL is further programmed to provide second audio clock logic that provides a second clock signal to the second audio interface logic based on PTP information derived using the second PA audio data or based on a buffer occupancy level indicating an amount of the second PA audio data currently remaining in an audio buffer; wherein organizing the audio data payload into the second formatted audio data includes providing the second formatted audio data in accordance with the second clock signal; wherein the PL is further programmed to provide Ethernet logic and data filter logic; wherein the Ethernet logic receives the first PA audio data and the second PA audio data via the network in Ethernet communication, extracts first network-layer audio data from the received first PA audio data, provides the extracted first network-layer audio data to the PS, derives the PTP information using the received second PA audio data or identifies the buffer occupancy level by buffering the received second PA audio data in the audio buffer, provides the derived PTP information or the identified buffer occupancy level to the second audio clock logic, extracts second network-layer audio data that includes the audio data payload from the received second PA audio data, and provides the extracted second network-layer audio data to the data filter logic; wherein the data filter logic extracts the audio data payload from the second network-layer audio data and provides the extracted audio data payload to the second audio interface logic; and wherein the software program further generates the encoded audio data from the extracted first network-layer audio data.

Example 13 includes the subject matter of Example 11 or 12, wherein the network-based PA receiver further includes a PHY device that establishes a physical link between the network and the PL; and wherein the Ethernet logic receives, through the physical link, the first PA audio data and the second PA audio data.

Example 14 includes the subject matter of any one of Examples 1 to 13, wherein the PL is further programmed to provide an audio selector that provides an audio output based on at least one of the first formatted audio data and the second formatted audio data.

Example 15 includes the subject matter of Example 14, wherein the audio selector includes a switch for switching between providing the first formatted audio data as the audio output and providing the second formatted audio data as the audio output.

Example 16 includes the subject matter of Example 14 or 15, wherein the audio selector includes an audio matrix that provides the audio output by routing, to an output channel in the audio output, at least one channel in the first formatted audio data, at least one channel in the second formatted audio data, or both.

Example 17 includes the subject matter of claim 16, wherein the output channel is a channel from the audio matrix to at least one audio processing apparatus.

Example 18 includes the subject matter of claim 17, wherein the at least one audio processing apparatus includes an audio amplifier, a speaker, an audio mixer, and/or another audio matrix.

Example 19 includes the subject matter of any one of Examples 14 to 18, wherein the audio selector includes an asynchronous sample rate converter (ASRC); wherein organizing the encoded audio data into the first formatted audio data includes providing, to the ASRC, the first formatted audio data in accordance with a first clock signal and/or organizing the audio data payload into the second formatted audio data includes providing, to the ASRC, the second formatted audio data in accordance with a second clock signal; wherein the ASRC resamples, in accordance with an output clock signal, the first formatted audio data and/or the second formatted audio data; and wherein the resampled first formatted audio data and/or the resampled second formatted audio data are provided as the audio output.

Example 20 includes the subject matter of any one of Examples 1 to 19, wherein the first PA audio data is received over the network in Transmission Control Protocol (TCP) packets or in User Datagram Protocol (UDP) packets; and wherein the second PA audio data is received over the network in UDP packets.

Example 21 includes the subject matter of any one of Examples 1 to 20, wherein the network includes a local area network (LAN) and a wide area network (WAN); wherein the first PA audio data is received via at least one of the LAN or the WAN; and wherein the second PA audio data is received via the LAN without traversing the WAN.

Example 22 includes the subject matter of any one of Examples 1 to 21, wherein the particular audio data representation format is an uncompressed digital audio representation format.

Example 23 includes the subject matter of any one of Examples 1 to 22, wherein the encoded audio data is pulse-code modulation (PCM)-encoded audio data.

Example 24 includes the subject matter of any one of Examples 1 to 23, wherein the particular transport protocol is a stateless protocol.

Example 25 includes the subject matter of any one of Examples 1 to 24, wherein the audio data payload is a Real-time Transport Protocol (RTP) packet payload.

Example 26 includes the subject matter of any one of Examples 1 to 25, wherein the first audio interface format is an Inter-IC Sound (I2S) interface format; and wherein the second audio interface format is a Time-Division Multiplexing (TDM) interface format that is other than the I2S interface format.

The foregoing description has been presented to illustrate and describe some examples in detail. It should be understood by those skilled in the art that many modifications and variations are possible in light of the above teaching. In various examples, suitable results may be achieved if the above-described techniques are performed in a different order, and/or if some of the components of the above-described systems, architectures, devices, circuits, and the like are coupled or combined in a different manner, or substituted for or replaced by other components or equivalents thereof.

Therefore, the scope of the disclosure is not to be limited to the precise form disclosed, but rather defined by the following claims and equivalents thereof.

What is claimed is:

1. A network-based public address (PA) receiver, comprising:
a system-on-chip (SoC) comprising a processing system (PS) and programmable logic (PL);
wherein the PS comprises a processor that executes a software program that outputs audio data encoded in a particular audio data representation format based on first PA audio data received via a network;
wherein the PL is programmed to provide first audio interface logic and second audio interface logic;
wherein the first audio interface logic organizes the encoded audio data into first formatted audio data according to a first audio interface format; and
wherein the second audio interface logic organizes, into second formatted audio data according to a second audio interface format, an audio data payload of a particular transport protocol that is extracted from second PA audio data received via the network.

2. The network-based PA receiver of claim 1,
wherein the software program further outputs play information regarding the encoded audio data;
wherein the PL is further programmed to provide first audio clock logic that provides, to the first audio interface logic, a first clock signal based on the play information; and
wherein organizing the encoded audio data into the first formatted audio data comprises providing the first formatted audio data in accordance with the first clock signal.

3. The network-based PA receiver of claim 1,
wherein the PL is further programmed to provide second audio clock logic that provides, to the second audio interface logic, a second clock signal based on precision time protocol (PTP) information derived using the second PA audio data or based on a buffer occupancy level indicating an amount of the second PA audio data currently remaining in an audio buffer; and
wherein organizing the audio data payload into the second formatted audio data comprises providing the second formatted audio data in accordance with the second clock signal.

4. The network-based PA receiver of claim 3,
wherein the PS further comprises input/output (I/O) peripherals that control Ethernet communication and receive the first PA audio data via the network in the Ethernet communication;
wherein the software program further generates the encoded audio data from the received first PA audio data;
wherein the PL is further programmed to provide Ethernet logic and an Ethernet controller;
wherein the Ethernet logic:
receives, via the network in separate Ethernet communication controlled by the Ethernet controller, the second PA audio data separately from the first PA audio data;
provides the received second PA audio data to the Ethernet controller;
derives the PTP information using the received second PA audio data or identifies the buffer occupancy level by buffering the received second PA audio data in the audio buffer; and
provides the derived PTP information or the identified buffer occupancy level to the second audio clock logic; and
wherein the Ethernet controller extracts the audio data payload from the second PA audio data and provides the extracted audio data payload to the second audio interface logic.

5. The network-based PA receiver of claim 4,
wherein the network-based PA receiver further comprises:
a first physical layer (PHY) device that establishes a first physical link between the network and the PS; and
a second PHY device that establishes a second physical link between the network and the PL;
wherein the I/O peripherals receive the first PA audio data through the first physical link; and
wherein the Ethernet logic receives the second PA audio data through the second physical link.

6. The network-based PA receiver of claim 3,
wherein the PS further comprises I/O peripherals that control Ethernet communication and receive, via the network in the Ethernet communication, the first PA audio data and the second PA audio data; and
wherein the software program further:
generates the encoded audio data from the received first PA audio data;
derives the PTP information using the received second PA audio data or identifies the buffer occupancy level by buffering the received second PA audio data in the audio buffer;
stores the derived PTP information or the identified buffer occupancy level in an embedded memory of the PL;
extracts the audio data payload from the received second PA audio data; and
stores the extracted audio data payload in the embedded memory.

7. The network-based PA receiver of claim 6,
wherein the network-based PA receiver further comprises a PHY device that establishes a physical link between the network and the PS; and
wherein the I/O peripherals receive, through the physical link, the first PA audio data and the second PA audio data.

8. The network-based PA receiver of claim 3,
wherein the PL is further programmed to provide Ethernet logic and data filter logic;
wherein the Ethernet logic:
receives, via the network in Ethernet communication controlled by the PS, the first PA audio data and the second PA audio data;
extracts first network-layer audio data from the received first PA audio data;
provides the extracted first network-layer audio data to the PS;
derives the PTP information using the received second PA audio data or identifies the buffer occupancy level by buffering the received second PA audio data in the audio buffer;
provides the derived PTP information or the identified buffer occupancy level to the second audio clock logic;
extracts second network-layer audio data that includes the audio data payload from the received second PA audio data; and
provides the extracted second network-layer audio data to the data filter logic;
wherein the data filter logic extracts the audio data payload from the second network-layer audio data and provides the extracted audio data payload to the second audio interface logic; and
wherein the software program further generates the encoded audio data from the extracted first network-layer audio data.

9. The network-based PA receiver of claim 8,
wherein the network-based PA receiver further comprises a PHY device that establishes a physical link between the network and the PL; and
wherein the Ethernet logic receives, through the physical link, the first PA audio data and the second PA audio data.

10. The network-based PA receiver of claim 1,
wherein the PL is further programmed to provide an audio selector that provides an audio output based on at least one of the first formatted audio data and the second formatted audio data.

11. The network-based PA receiver of claim 10,
wherein the audio selector comprises a switch for switching between providing the first formatted audio data as the audio output and providing the second formatted audio data as the audio output.

12. The network-based PA receiver of claim 10,
wherein the audio selector comprises an audio matrix that provides the audio output by routing, to an output channel in the audio output, at least one channel in the first formatted audio data, at least one channel in the second formatted audio data, or both.

13. The network-based PA receiver of claim 10,
wherein the audio selector comprises an asynchronous sample rate converter (ASRC);
wherein organizing the encoded audio data into the first formatted audio data comprises providing, to the ASRC, the first formatted audio data in accordance with a first clock signal and/or organizing the audio data payload into the second formatted audio data comprises providing, to the ASRC, the second formatted audio data in accordance with a second clock signal;
wherein the ASRC resamples, in accordance with an output clock signal, the first formatted audio data and/or the second formatted audio data; and
wherein the resampled first formatted audio data and/or the resampled second formatted audio data are provided as the audio output.

14. The network-based PA receiver of claim 1,
wherein the first PA audio data is received over the network in Transmission Control Protocol (TCP) packets or in User Datagram Protocol (UDP) packets; and
wherein the second PA audio data is received over the network in UDP packets.

15. The network-based PA receiver of claim 1,
wherein the first audio interface format is an Inter-IC Sound (I2S) interface format; and
wherein the second audio interface format is a Time-Division Multiplexing (TDM) interface format that is other than the I2S interface format.
